(19) United States
(12) Patent Application Publication
(10) Pub. No.: US 2026/0307773 A1
(43) Pub. Date: Oct. 8, 2026

(54) SHAFT BEARING

(71) Applicants: TKMS GmbH, Kiel (DE); thyssenkrupp AG, Essen (DE)

(72) Inventor: Michael TESKE, Zarnekau / Suesel (DE)

(73) Assignees: TKMS GmbH, Kiel (DE); thyssenkrupp AG, Essen (DE)

(21) Appl. No.: 19/483,554

(22) PCT Filed: May 3, 2024
(86) PCT No.: PCT/EP2024/062198

§ 371 Date: Nov. 11, 2025

(30) Foreign Application Priority Data
May 12, 2023 (DE) 10 2023 112 673.3

(51) Int. Cl. B63H 23/32; B63G 8/08; F16C 19/18; F16C 23/08

(52) U.S. Cl. CPC B63H 23/321; B63G 8/08; F16C 19/184; F16C 23/08; B63H 2023/325; F16C 2206/40; F16C 2326/30

(57) ABSTRACT

A shaft bearing comprises a bearing housing and a shaft, wherein the shaft bearing has a first axial bearing, a second axial bearing and at least a first radial bearing, wherein the shaft has, inside the bearing housing and between the first axial bearing and the second axial bearing, at least one thickened portion, wherein the first axial bearing has, by means of a first pressure element, a static preload in the axial direction, wherein the second axial bearing has, by means of a second pressure element, a static preload in the axial direction.

The invention relates to a shaft bearing which is designed to absorb forces and can therefore be used in a watercraft with a lightweight supporting structure, in particular a modular, unmanned underwater vehicle.

Particularly in manned underwater vehicles, dispensing with a pressure hull allows the use of a comparatively light supporting structure. In particular, large portions of an unmanned underwater vehicle of this kind may also be flushed through by water.

A further consequence of the substantial mass reduction—achieved by omitting structures required for carrying people—is that comparatively simple and lightweight motors can also be used as traction motors.

Nevertheless, geometric requirements often make a longer shaft between motor and propeller necessary.

FR 494 165 A discloses an improvement in thrust collars or thrust bearings.

CN 203 246 580 U discloses a deep-sea high-temperature miniature underwater propeller with magnetic transmission and pressure compensation.

DE 10 2015 100 502 B 4 discloses an underwater drive unit.

DE 31 12 306 A 1 discloses a vibration-damped ship thrust bearing.

DE 10 2006 018 264 A 1 discloses a bearing arrangement.

JP S56-157426 U .

The object of the invention is to provide a shaft bearing which is capable of absorbing the forces—including the axial forces of a propulsion propeller—and is therefore suitable for use in an unmanned underwater vehicle, in particular a modular one.

This object is achieved by the shaft bearing having the features indicated in claim 1.

Advantageous developments emerge from the dependent claims, the following description and the drawings.

The shaft bearing according to the invention comprising the bearing housing and a shaft. The shaft bearing has a first axial bearing, a second axial bearing, and at least a first radial bearing. The shaft has, inside the bearing housing and between the first axial bearing and the second axial bearing, at least one thickened portion. This means that the diameter of the shaft is greater in the region of the thickened portion. In this way, it is possible to absorb axial forces—i.e. forces directed along the longitudinal axis of the shaft. The thickening in this case may be continuous between the first axial bearing and the second axial bearing, or there may be two separate thickenings. The second variant allows weight to be saved on the shaft. The first axial bearing has, by means of a first pressure element, a static preload in the axial direction. The second axial bearing has, by means of a second pressure element, a static preload in the axial direction. Without the preload, the deflection typical of a propeller shaft could result in at least at one of the axial bearings being excessively unloaded on one side, leading to displacement within the axial bearing and, consequently, damage. This is prevented in that the two axial bearings each have their own preload, and the reliability of the axial bearings is thereby guaranteed.

In a further embodiment of the invention, the shaft bearing has a second radial bearing. This enables more reliable support and, at the same time, ensures secure running even when the shaft undergoes deflection.

In a further embodiment of the invention, the first radial bearing, and preferably also the optional second radial bearing, is a self-aligning ball bearing. Self-aligning ball bearings are described, for example, in DIN 630 and are particularly suitable for ensuring reliable support even when the shaft bends.

In a further embodiment of the invention, the first pressure element is arranged between the first axial bearing and the shaft. The second pressure element is arranged between the second axial bearing and the shaft. This allows the first and second axial bearings to be rigidly, and therefore more stably, fastened to the bearing housing.

In a further embodiment of the invention, the first radial bearing is arranged between the first axial bearing and the second axial bearing in the region of the thickened portion. This provides optimal force distribution, in particular also in the event of undesired shaft deflection.

In a further embodiment of the invention, the first radial bearing and the second radial bearing form a force-transmitting connection between the shaft and the bearing housing. This means that forces can be transmitted directly, and without further components lying therebetween, from the shaft to the first radial bearing and from the first radial bearing to the bearing housing. In this way, forces can be transmitted very reliably, particularly also in the event of unwanted shaft deflection.

In a further embodiment of the invention, the bearing housing is water-flushed. The advantage is that the shaft bearing does not therefore have to be of pressure-resistant design, in order to withstand the external water pressure. Alternatively, the shaft bearing could be filled with a non-compressible, or only very slightly compressible, liquid and preferably have pressure equalization in respect of the surroundings. In this case, however, appropriate shaft sealing must be provided, which in turn increases frictional resistance in operation and therefore wear.

In a further embodiment of the invention, the bearing housing has a water inlet. The water inlet has a filter. The main problem with a water-flushed bearing, as with any other component, is fouling. The filter is intended to permit pressure equalization while preventing the ingress of sand and, above all, living organisms too, in order to avoid fouling inside the bearing housing.

In a further embodiment of the invention, the first axial bearing and the second axial bearing are thrust ball bearings.

In a further embodiment of the invention, the first axial bearing, the second axial bearing and the first radial bearing are ceramic bearings. The use of ceramic avoids corrosion problems. Moreover, bearings of this kind have proved particularly suitable in an aqueous environment.

In a further embodiment of the invention, the first axial bearing and the second axial bearing are loaded by means of springs with an adjustable preload. The advantage is that installing the springs allows the preload to be set precisely during installation, making it easy to compensate for manufacturing tolerances. In this embodiment it may be provided that the radial bearings are fixed on the shaft but, with their bearing race on the bearing housing, are not fixed in the axial direction, so that they can follow the movement of the springs. This can be particularly helpful in preventing binding in the radial bearings when an axial load occurs during installation or operation.

In a further aspect, the invention relates to an underwater vehicle having a drive motor, a propeller, and a shaft bearing according to the invention with a shaft. The shaft bearing is arranged between the propeller and the drive motor. The shaft bearing therefore absorbs all axial forces, in particular the forces generated by propulsive thrust, so that the drive motor is not subjected to them. This enables the use of comparatively simple and lightweight motors, which are particularly suitable for use in an unmanned underwater vehicle. The shaft bearing is connected to the structure of the underwater vehicle. The structure should be taken to mean the totality of the load-bearing parts. In an unmanned underwater vehicle, in particular in a modular underwater vehicle, this may be a simple frame structure. In particular, the drive motor, the shaft bearing and the shaft are arranged in a water-washed region of the underwater vehicle. In a manned submarine, the pressure hull invariably provides a massive structure that can easily be loaded with forces; this, however, is absent in unmanned systems. The shaft may be multipart. In particular, the shaft may be separated between the shaft bearing and the drive motor, so that the shaft preferably has a connecting element behind the shaft bearing and in front of the drive motor, respectively.

In a further embodiment of the invention, the propeller is arranged directly adjacent to the shaft bearing. The shorter the distance between the propeller and the shaft bearing, the smaller the shaft deflections. Here again, the unmanned underwater vehicle is preferred, since in a manned underwater vehicle the pressure hull—as the most important part of the load-bearing structure—generally lies at a greater distance from the propeller, because in the stern region a hydrodynamically optimized secondary hull occupies the space between the pressure hull and the propeller. For a shaft that is more than three times as long as the length of the shaft bearing, the shaft bearing is preferably arranged in the third of the shaft length assigned to the propeller.

In a further embodiment of the invention, a hollow shaft is arranged between the shaft bearing and the drive motor. On the one hand, this region is free of axial forces by virtue of the shaft bearing, so that this region of the shaft need only transmit the rotational movement. On the other hand, this saves weight and, at the same time, reduces the shaft torque due to the lower mass.

In a further embodiment of the invention, the underwater vehicle is an unmanned underwater vehicle, preferably a modular unmanned underwater vehicle.

By way of example, the entire drivetrain of the underwater vehicle may be configured as follows:

The drive motor typically has a very short shaft projecting from the motor. This motor shaft is connected to a hollow shaft by way of a connecting element. At its opposite end, the hollow shaft is connected by a further connecting element to the shaft projecting from the shaft bearing. The hollow shaft is preferably supported by one, and particularly preferably by two, radial bearings. Since, by means of the shaft bearing according to the invention, all forces originating from the propeller are absorbed, the radial bearings of the hollow shaft can be of simple design. It is merely advantageous for these radial bearings to have seals, wherein these seals serve only to prevent the ingress of foreign matter, such as sand or fouling. The propeller is preferably connected directly to the shaft of the shaft bearing and therefore is only a very small distance from the shaft bearing. This minimizes shaft deflection.

In a modular construction of the underwater vehicle, the drive motor, the shaft bearing and the propeller are preferably arranged in a common module. Preferably, this drive module also includes the rudder. The drive motor is preferably an electric drive motor, so that only an electrical connection needs to be made to a module having an energy generation device, for example a fuel-cell device, and/or to a module having an energy storage device, for example an accumulator. Preferably, the entire drive module is water-flushed and has only a hydrodynamic outer fairing.

The shaft bearing according to the invention is explained in more detail below with reference to an embodiment shown in the drawings.

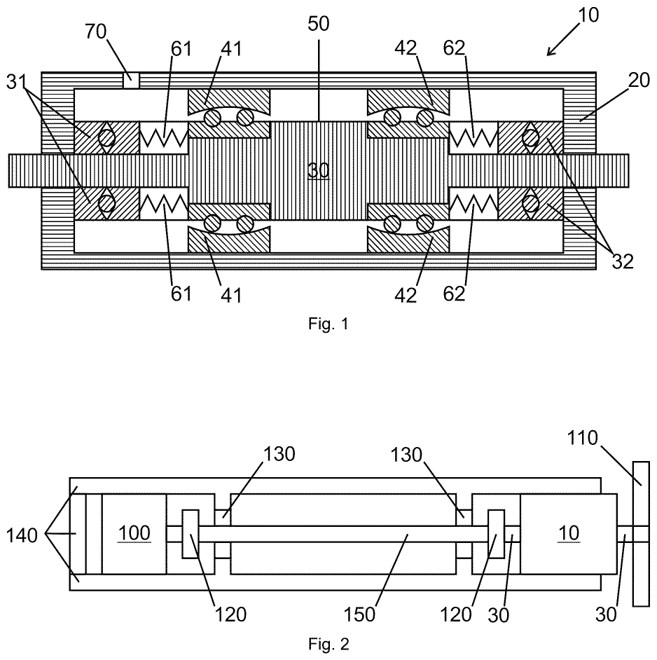

FIG. 1: cross section

FIG. 2: drive module

In FIG. 1, a cross section through an exemplary shaft bearing 10 is shown. The depiction is purely schematic and not to scale. The shaft bearing 10 has a bearing housing 20. This is, for example, connected directly to the structure of an underwater vehicle and can therefore introduce the propulsive force generated by the propeller directly into the structure. The shaft 30 runs through the bearing housing 20. For example, the shaft 30 may be connected on one side to a propeller, and on the other to a drive motor.

The shaft bearing 10 has a total of four bearings 31, 32, 41, 42 which are capable of absorbing forces from the shaft 30. Essential for propulsion are the first axial bearing 31 and the second axial bearing 32. By means of these two axial bearings 31, 32, forces acting along the shaft 30, i.e. in particular the propulsive thrust, are transmitted from the shaft 30 to the bearing housing 20 and therefore ultimately to the structure to which the bearing housing 20 is connected. The advantage is that, on the motor side, the shaft 30 is therefore free of axial forces, so that the drive motor does not have to absorb the propulsive forces. A symmetrical configuration is necessary, in order to allow both ahead and astern running. In order to transfer the forces from the shaft 30 to the axial bearings 31, 32, the shaft 30 has, inside the bearing housing 20, a thickened portion 50, thereby providing lateral abutment faces for the axial bearings 31, 32 against which they lie.

Furthermore, the shaft bearing has two radial bearings 41, 42 designed as self-aligning ball bearings. Owing to the arcuate raceway geometry of the self-aligning ball bearing, the first radial bearing 41 and the second radial bearing 42 can compensate for a certain bending of the shaft 30. However, shaft 30 bending could lead to the first axial bearing 31 or the second axial bearing 32 being locally unloaded to such an extent that the bearing could be damaged. To prevent this, the shaft bearing 10 has a first pressure element 61 at the first axial bearing 31 and a second pressure element 62 at the second axial bearing 32. The first pressure element 61 and the second pressure element 62 each have a plurality of spring elements which ensure that the axial bearings 31, 32 always maintain a minimum load and therefore remain stable.

To achieve pressure equalization, the bearing housing 20 has a water inlet with a filter 70. This allows ambient water to enter the interior so that pressure is equalized. The filter 70 largely prevents fouling inside the bearing housing 20. Nevertheless, in order to achieve a sufficient service life of the bearings 31, 32, 41, 42, these are ceramic bearings.

In FIG. 2, a drive module is shown by way of example. The drive module has a supporting structure 140, for example a steel frame. The drive motor 100 and the shaft bearing 10 are fastened to the structure 140. A hollow shaft 150 is arranged between the drive motor 100 and the shaft bearing 10, which hollow shaft is connected via a connecting element 120 to the shaft of the drive motor 100 and, on the opposite side, via a connecting element 120 to the shaft 30 of the shaft bearing 10. For support, the hollow shaft 150 is carried by two radial bearings 130, which are designed as simple ceramic rolling bearings provided only with seals. The sealing of the radial bearings 130 serves solely to prevent the ingress of foreign matter and to avoid fouling. The propeller 110 is arranged on the shaft 30 of the shaft bearing 10 in the immediate vicinity of the shaft bearing 10. All propulsive forces generated by the propeller 110 are transmitted directly to the shaft bearing 10 and from there introduced into the structure 140. The drive motor 100 therefore remains unloaded by the propulsive forces.

### LIST OF REFERENCE SIGNS

10 shaft bearing
20 bearing housing
30 shaft
31 first axial bearing
32 second axial bearing
41 first radial bearing
42 second radial bearing
50 thickened portion
61 first pressure element
62 second pressure element
70 filter
100 drive motor
110 propeller
120 connecting element
130 radial bearing
140 structure
150 hollow shaft

1-13. (canceled)

14. A shaft bearing system, comprising:
a bearing housing;
a shaft;
a first axial bearing;
a second axial bearing; and
at least a first radial bearing;
wherein the shaft has, inside the bearing housing and between the first axial bearing and the second axial bearing, at least one thickened portion;
wherein the first axial bearing has a static preload in the axial direction applied by a first pressure element;
wherein the second axial bearing has a static preload in the axial direction applied by a second pressure element.

15. The shaft bearing as claimed in claim 14, wherein the shaft bearing has a second radial bearing.

16. The shaft bearing as claimed in claim 14, wherein the first pressure element is arranged between the first axial bearing and the shaft, wherein the second pressure element is arranged between the second axial bearing and the shaft.

17. The shaft bearing as claimed in claim 14, wherein the first radial bearing is arranged between the first axial bearing and the second axial bearing in the region of the thickened portion.

18. The shaft bearing as claimed in claim 14, wherein the first radial bearing is a self-aligning ball bearing.

19. The shaft bearing as claimed in claim 14, wherein the bearing housing is water-flushed.

20. The shaft bearing as claimed in claim 19, wherein the bearing housing has a water inlet, wherein the water inlet has a filter.

21. The shaft bearing as claimed in claim 14, wherein the first axial bearing and the second axial bearing are thrust ball bearings.

22. The shaft bearing as claimed in claim 14, wherein the first axial bearing, the second axial bearing and the first radial bearing are ceramic bearings.

23. The shaft bearing as claimed in claim 14, wherein the first axial bearing and the second axial bearing are loaded by springs with an adjustable preload.

24. An underwater vehicle, comprising:
a drive motor;
a propeller; and
a shaft bearing as claimed in claim 14;
wherein the shaft bearing is arranged between the propeller and the drive motor;
wherein the shaft bearing is connected to the structure of the underwater vehicle.

25. The underwater vehicle as claimed in claim 24, wherein the propeller is arranged directly adjacent to the shaft bearing.

26. The underwater vehicle as claimed in claim 24, wherein a hollow shaft is arranged between the shaft bearing and the drive motor.
